(19) United States
(12) Patent Application Publication
(10) Pub. No.: US 2007/0022186 A1
(43) Pub. Date: Jan. 25, 2007

(54) Computer peripheral and method of updating files thereof

(75) Inventor: Chien-Hung Chen, Hsinchu (TW)

Correspondence Address: BIRCH STEWART KOLASCH & BIRCH, PO BOX 747, FALLS CHURCH, VA, 22040-0747, US

(73) Assignee: Avision Inc.

(21) Appl. No.: 11/491,134

(22) Filed: Jul. 24, 2006

(30) Foreign Application Priority Data
Jul. 25, 2005 (TW) 94125171

(51) Int. Cl. G06F 15/177; G06F 15/173

(52) U.S. Cl. 709/220

(57) ABSTRACT

A computer peripheral and a method of updating files thereof are provided. The computer peripheral is connected to a server via Internet network. A file and an use record file are stored in the computer peripheral. The version of the file is recorded in the use record file. Firstly, the computer peripheral is connected to a server via Internet network. Next, the computer peripheral transmits the use record file to the server. Finally, the server receives and stores the use record file.

This application claims the benefit of Taiwan application Serial No. 94125171, filed Jul. 25, 2005, the subject matter of which is incorporated herein by reference.

### BACKGROUND OF THE INVENTION

1. Field of the Invention

The invention relates in general to a computer peripheral, and more particularly to a computer peripheral which is automatically or passively activated to transmit an use record file to a server via Internet network and then processes file updating according to the file with newer server version and the method of updating files thereof.

2. Description of the Related Art

With the advance in science and technology, computers and the Internet have become indispensable tools to modern people in their everyday life. The user can get connected to the Internet via a computer. The user can browse the servers, the databases or the websites in the Internet in the computer, so that the user can absorb or download the most updated information and knowledge. Particularly, the introduction of computer peripheral provides modern people with more convenience in their everyday life. Computer peripheral include scanners, facsimile machines, printers, copiers and multi-function machines, and are further equipped with network connection.

Computer peripheral include drivers and firmware. The drivers and the firmware are like the heart of computer peripheral, and the quality of the driver and the firmware has much to do with the performance of computer peripheral. Therefore, the manufacturers have always been devoted to the research and development of the driver and the firmware of computer peripheral with an aim to achieve a better performance of computer peripheral. Despite the manufacturers have developed a driver or a firmware of a newer version, the manufacturers are unable to send the driver or the firmware of a newer version to the users of computer peripheral via Internet network because the users' Internet protocol (IP) addresses are unknown to the manufacturers. Normally, only when the users have informed the manufacturers that the computer peripheral has bugs or that the driver or firmware of computer peripheral needs to be updated, will the manufacturers send a driver or firmware of a newer version to the users by e-mail or other transmission methods via Internet network. Then, the users download the driver or firmware of a newer version to update their computer peripheral.

Besides, the users have to spend lots of time updating the driver or firmware of computer peripheral manually. The file updating procedure is very complicated. Moreover, the goodwill of a manufacturer will be damaged if the manufacturer is passively informed by the user after the users have found the computer peripheral to have bugs. This is what a manufacturer does not want to see. If the manufacturers would like to obtain the use record of the computer peripheral from the users, the manufacturers can only make inquiries via phone or e-mails. However, the users may not keep in touch with the manufacturers patiently, so that the manufacturers may not be able to obtain the after-sale status of the computer peripheral.

### SUMMARY OF THE INVENTION

It is therefore an object of the invention to provide a computer peripheral and a method of updating files thereof. The design of enabling an user's computer peripheral to transmit an use record to the manufacturer's server via Internet network automatically or passively allows the server to determine whether to transmit a file of a newer version to the user's computer peripheral. Moreover, after the computer peripheral receives the file of a newer version transmitted by the server, the computer peripheral can update file more effectively and conveniently, avoiding spending a large amount of time updating the file of computer peripheral, and largely transcending the restriction of updating files manually imposed by a conventional computer peripheral.

The invention achieves the above-identified object by providing a method of updating files applied in a computer peripheral. The computer peripheral is connected to a server via Internet network. A file and an use record file are stored in the computer peripheral. The use record file at least records the version of the file. According to the method of the invention, firstly, the computer peripheral is connected to the server via Internet network. Next, the computer peripheral transmits the use record file to the server. Finally, the server receives and stores the use record file.

The invention further achieves the above-identified object by providing a computer peripheral. The computer peripheral includes a storage unit, a network link unit and a control unit. A first file and an use record file are stored in the storage unit. The use record file at least records the version of a file. The network link unit enables the computer peripheral to be connected to a server via Internet network. The control unit controls the network link unit to be connected to the server via Internet network, and transmits the use record file stored in the storage unit to the server via the network link unit.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a diagram showing the linkage among a computer peripheral, Internet network, and a server according to a first embodiment of the invention;

FIG. 2 is a diagram of an user-confirmation frame displayed on the display unit of FIG. 1;

FIG. 3 is a diagram showing the linkage among a computer peripheral, Internet network, and a server according to a second embodiment of the invention;

FIG. 4 is a diagram showing the linkage among a computer peripheral, Internet network, and a server according to a third embodiment of the invention;

FIG. 5 is a diagram of a file-updating menu displayed on the display unit of FIG. 4;

FIG. 6 is a method flowchart of updating files of the computer peripheral according to a fourth embodiment of the invention;

FIG. 7 is a flowchart of updating files after step 65; and

FIG. 8 is another flowchart of updating files after step 65.

### DETAILED DESCRIPTION OF THE INVENTION

The invention provides a computer peripheral and a method of updating files thereof. The computer peripheral is automatically or passively connected to a specific server having Internet protocol (IP) address via Internet network. The computer peripheral stores a first file, an use record file and the specific IP address. The use record file records the version of the first file. The server stores a second file. When the computer peripheral is connected to the server, the computer peripheral actively transmits the use record file to the server. The server receives also stores the use record file and obtains the IP address of the computer peripheral. The server determines whether the version of the second file is newer than the version of the first file according to the second file and the use record file. The server further determines whether to transmit the second file to the computer peripheral for the computer peripheral to update the file. As for the practical application of the invention is exemplified by several embodiments accompanied by drawings below. First Embodiment

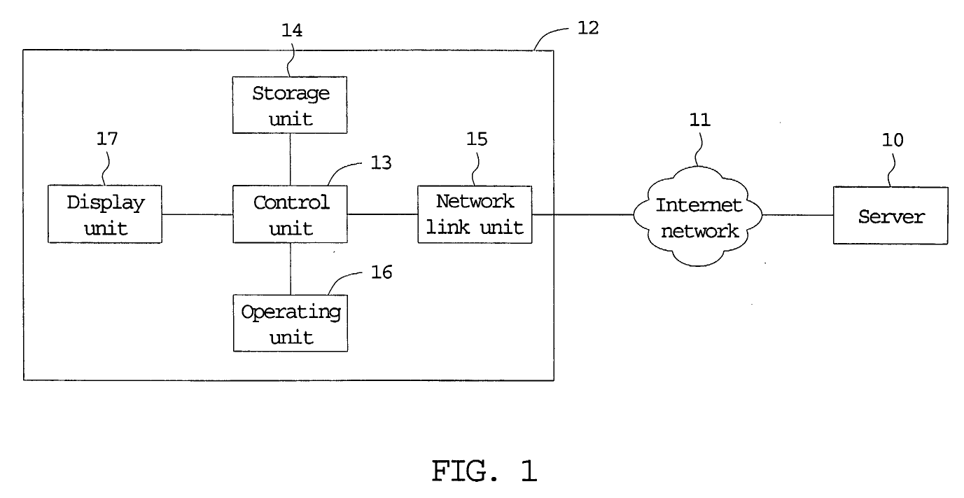

Referring to FIG. 1, a diagram showing the linkage among a computer peripheral, Internet network, and a server according to a first embodiment of the invention is shown. In FIG. 1, the computer peripheral 12 is connected to the server 10 via Internet network 11. The computer peripheral 12 includes a network link unit 15, a storage unit 14, a display unit 17, an operating unit 16 and a control unit 13. The network link unit 15, the storage unit 14, the display unit 17, and the operating unit 16 are electrically coupled to the control unit 13, respectively. Besides, the computer peripheral 12 also includes a scanning unit, a facsimile unit, a printing unit, a auto-feed unit and a computer connection unit, all of which are electrically coupled to the control unit 16 for scanning documents, receiving/transmitting data, receiving/sending e-mails, printing and copying materials, auto-feeding and being connected to the computer.

The network link unit 15 enables the computer peripheral 12 to be connected to the server 10 via Internet network 11. The server 10 stores a specific Internet protocol (IP) address and a second file. Examples of the server 10 include databases or website stations installed in Internet network 11 by the manufacturer of the computer peripheral 12, and the server 10 can be positioned at any node of Internet network. The storage unit 14 stores a first file, an use record file and a specific IP address of the server 10. Examples of the first file include drivers and firmwares. The use record file at least records the version of the first file. Before the computer peripheral 12 leaves the manufacturer, the manufacturer in-builds a specific IP address in the server 10 of the computer peripheral 12. Through the protocol between the computer peripheral 12 and the server 10, the computer peripheral 12 is able to connect any node of Internet network 11 to the server 10. Besides, both the second file and the first file belong to the same driver or firmware, but the version of the first file and the version of the second file, which may or may not be the same, are determined by the server 10 according to the second file and the use record file.

In the present embodiment of the invention, the control unit 13 controls the network link unit 15 to be automatically connected to the server 10 via Internet network 11 at a default time (12 pm for instance) or a default period (every three hours for instance) or when the computer peripheral 12 is at an idle mode. The control unit 13 transmits the use record file stored in the storage unit 14 to the server 10 via the network link unit 15 for the server 10 to determine whether to update the file of the computer peripheral 12. Therefore, the computer peripheral 12 is automatically connected to the server 10 via Internet network 11 and transmits the use record file to the server 10 at the specific time, the specific period or the idle mode.

When the server 10 receives and stores the use record file, the server 10 obtains the IP address of the computer peripheral 12 and obtains the model of the computer peripheral 12 and the version of the first file from the use record file. The server 10 stores different files required by the computer peripheral of various models. In the present embodiment of the invention, after the server 10 receives the use record file of computer peripheral 12, the server 10 seeks for the second file possessing the same features with the first file according to the model of the computer peripheral 12. The server 10 determines whether the version of the second file is newer than the version of the first file according to the use record file and the second file, and then determines whether to transmit the second file to the computer peripheral 12.

When the server 10 determines that the version of the second file is newer than the version of the first file, the server 10 transmits the second file of a newer version to the computer peripheral 12 via Internet network 11 for the computer peripheral 12 to update files.

When the server 10 determines that the version of the second file is not newer than the version of the first file, for instance, the version of the second file is the same as the version of the first file, the server 10 does not have to transmit the second file to the computer peripheral 12.

The ways of updating files after the computer peripheral 12 receives the second file from the server 10 are disclosed below.

In the first way of updating files, the control unit 13 receives the second file via the network link unit 15, and then stores the received second file in the storage unit 14. Meanwhile, the control unit 13 is able to replace the first file of a newer version with the second file of an older version to complete file updating without waiting for the user to determine whether to process file-updating. Furthermore, the first file of an older version can be selectively maintained or deleted.

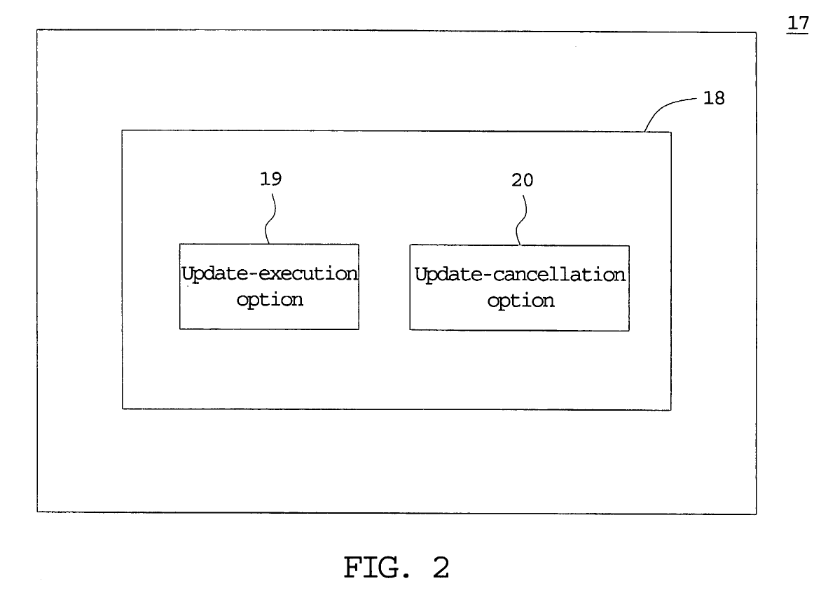

In the second way of updating files, the control unit 13 receives the second file via the network link unit 15, and then stores the received second file in the storage unit 14. As shown in FIG. 2, the control unit 13 controls the display unit 17 to display an user-confirmation frame 18 having an update-execution option 19 and an update-cancellation option 20 for the user to select via the operating unit 16. When the user selects the update-execution option 19 via the operating unit 16, the control unit 13 replaces the first file of an older version with the second file of a newer version to complete file updating, and the first file of an older version can be maintained or deleted. When the user selects the update-cancellation option 20 via the operating unit 13, the control unit 13 does not replace the first file of an older version with the second file of a newer version. The user can choose to maintain the second file until the file is updated in the future.

However, any one who is skilled in the technology of the present embodiment of the invention will understand that the technology of the present embodiment of the invention is not limited thereto. For example, the user can set a default time or a default period in the computer peripheral 12 via the operating unit 16. The default time or the default period can be changed according to the user's needs. Or, the default time or the default period is in-built in the computer peripheral 12 before leaving the manufacturer. However, the default time or the default period is fixed and not be changed by the user. Besides, the aforementioned idle mode includes a stand-by mode, an energy-saving mode and a sleep mode. The display unit 17 and the operating unit 16 can be a touch control display panel, and the storage unit 14 can be a non-volatile memory. The use record file further records the information of the computer peripheral 12 such as the model of the computer peripheral, the occurrences of scanning, the occurrences of printing, the occurrences of copying, the occurrences of paper jam, the occurrences of receiving/transmitting facsimiles, the occurrences of e-mails, the occurrences of shut downs, the occurrences of carbon toner cartridge replacement, and the carbon toner cartridge replacement time. The manufacturer can obtain the operating efficiency and the record of use of the computer peripheral 12 from the use record file transmitted to the server 10 by the computer peripheral 12.

### Second Embodiment

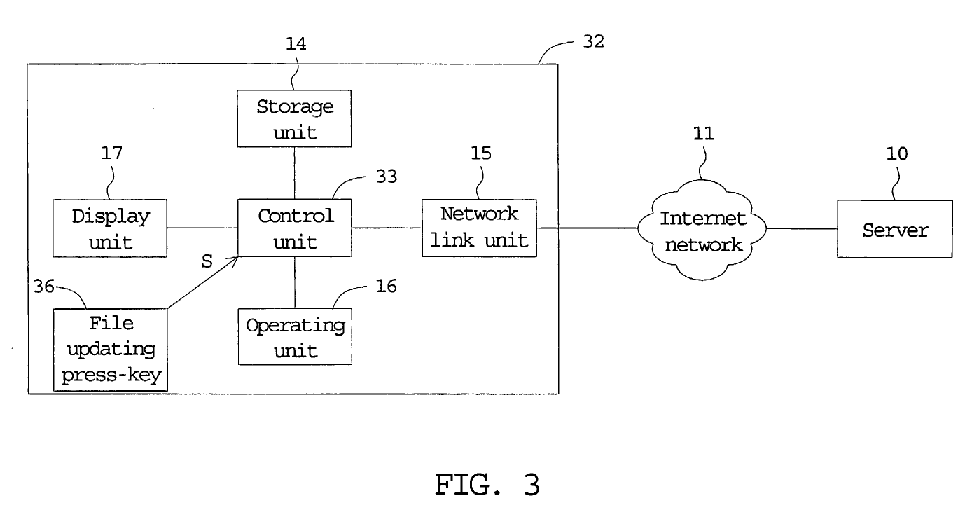

Referring to FIG. 3, is a diagram showing the linkage among a computer peripheral, Internet network, and a server according to a second embodiment of the invention is shown. The computer peripheral 32 of the present embodiment of the invention differs with the computer peripheral 12 of the first embodiment in that the control unit 33, the file updating press-key 36, and the way to activate the computer peripheral 32 to be connected to the server 10 via Internet network 11. As for other similar components, the same reference numbers are used and are not repeated here.

In FIG. 3, when the user activates the file updating press-key 36, the file updating press-key 36 outputs a file updating instruction S accordingly. In the present embodiment of the invention, the control unit 33 receives the file updating instruction S, and accordingly controls the network link unit 15 to be connected to the server 10 via Internet network 11. The control unit 33 transmits the use record file stored in the storage unit 14 to the server 10 via the network link unit 15. Therefore, the computer peripheral 32 is connected to the server 10 via Internet network 11, and then transmits the use record file to the server 10.

When the server 10 receives and stores the use record file, the server 10 obtains the IP address of the computer peripheral 32 and obtains the model and the version of the first file of the computer peripheral 32 from the use record file. The server 10 stores different files required by various models of the computer peripheral. In the present embodiment of the invention, after the server 10 receives the use record file of the computer peripheral 32, the server 10 seeks for the second file possessing the same features with the first file according to the model of computer peripheral 32. The server 10 determines whether the version of the second file is newer than the version of the first file according to the use record file and the second file, and then determines whether to transmit the second file to the computer peripheral 32.

When the server 10 determines that the version of the second file is newer than the version of the first file, the server 10 transmits the second file of a newer version to the computer peripheral 32 via Internet network 11 for the computer peripheral 32 to update files.

When the server 10 determines that the version of the second file is not newer than the version of the first file, for instance, the version of the second file is the same as the version of the first file, the server 10 does not have to transmit the second file to the computer peripheral 32.

The way of updating files by the computer peripheral 32 of the present embodiment after receiving the second file is the same as the way of updating files by the computer peripheral 12 of the first embodiment after receiving the second file, and is not repeated here. However, anyone who is skilled in the technology of the present embodiment of the invention will understand that the technology of the invention is not limited thereto. For example, the display unit 17, the operating unit 16 and file updating press-key 36 can be a touch control display panel.

### Third Embodiment

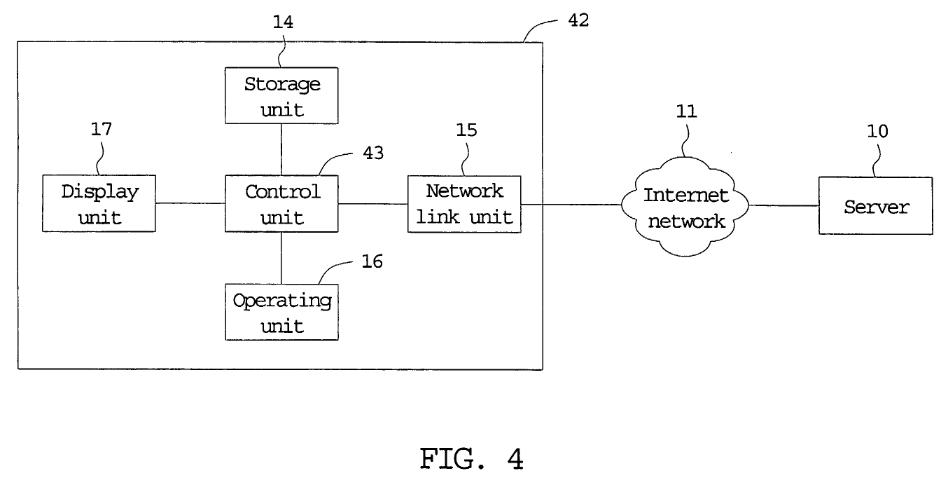

Referring to FIG. 4, is a diagram showing the linkage among a computer peripheral, Internet network, and a server according to a third embodiment of the invention is shown. The computer peripheral 42 of the present embodiment of the invention differs with the computer peripheral 12 of the first embodiment in that the control unit 43, the frame displayed on the display unit 17 and the way to activate the computer peripheral 42 to be connected to the server 10 via Internet network 11. As for other similar components, the same reference numbers are used and are not repeated here.

In FIG. 4, when the user activates the control unit 43 via the operating unit 16, the control unit 43 controls the display unit 17 to display a file-updating menu 58 as shown in FIG. 4. In FIG. 4, the file-updating menu 58 includes a first file option 59 corresponding to the first file. When the user via the operating unit 16 selects the first file option 59, the user would like to update the first file only. Meanwhile, the control unit 43 controls the network link unit 15 to be connected to the server 10 via Internet network 11. The control unit 43 transmits the use record file stored in the storage unit 14 to the server 10 via the network link unit 15.

Therefore, the computer peripheral 42 displays the file-updating menu 58 on the display unit 17 when the operating unit 16 is activated. Next, when the user via the operating unit 16 selects the first file option 59 of the file-updating menu 58, the computer peripheral 42 is connected to the server 10 via Internet network 11, and the use record file is transmitted to the server 10.

When the server 10 receives and stores the use record file, the server 10 obtains the IP address of the computer peripheral 42, and obtains the model and the version of the first file of computer peripheral 32 from the use record file. The server 10 stores different files required by various models of the computer peripheral. In the present embodiment of the invention, after the server 10 receives the use record file of the computer peripheral 42, the server 10 seeks for the second file possessing the same features with the first file according to the model of the computer peripheral 42. The server 10 determines whether the version of the second file is newer than the version of the first file according to the use record file and the second file, and then determines whether to transmit the second file to the computer peripheral 42.

When the server 10 determines that the version of the second file is newer than the version of the first file, the server 10 transmits the second file of a newer version to the computer peripheral 42 via Internet network 11 for the computer peripheral 42 to update files.

When the server 10 determines that the version of the second file is not newer than the version of the first file, for instance, the version of the second file is the same as the version of the first file, the server 10 does not have to transmit the second file to the computer peripheral 42.

The way of updating files by the computer peripheral 42 of the present embodiment after receiving the second file is the same as the computer peripheral 12 of the first embodiment after receiving the second file, and is not repeated here. However, anyone who is skilled in the technology of the present embodiment of the invention will understand that the technology of the invention is not limited thereto. For example, the display unit 17 and the operating unit 16 can be a touch control display panel.

### Fourth Embodiment

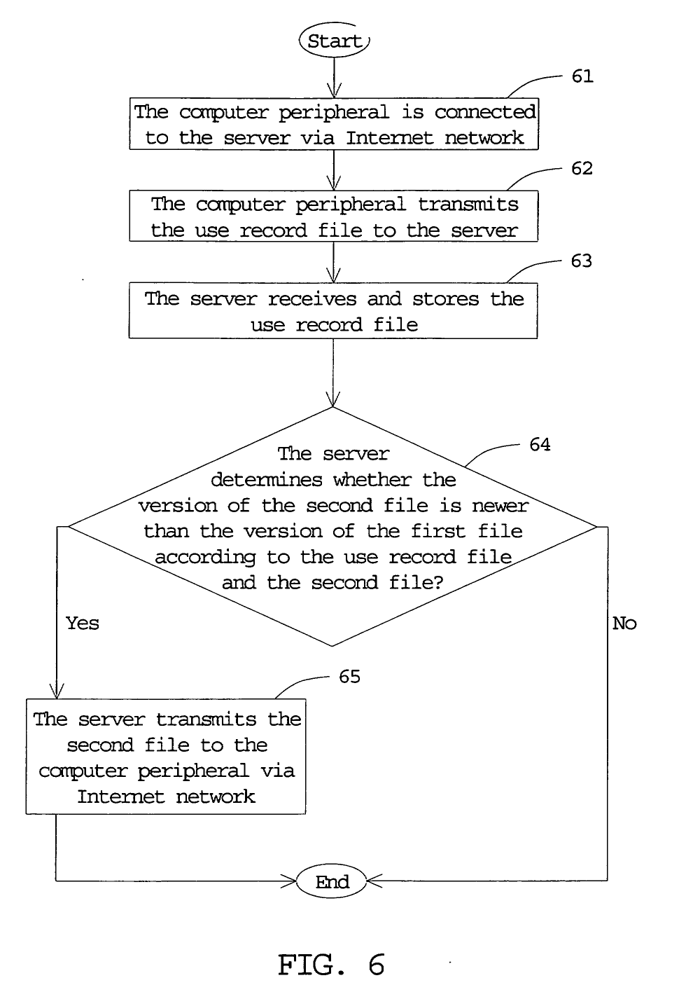

Referring to FIG. 6, a method flowchart of updating files of the computer peripheral according to a fourth embodiment of the invention is shown. The method of the present embodiment of the invention is applied in the computer peripherals 12, 32 and 42 of the above embodiments. The computer peripherals 12, 32 and 42 are all connected to server 10 via Internet network 11. The server 10 stores a specific IP address and a second file. Each of the computer peripherals 12, 32 and 42 stores a first file, an use record file and a specific IP address. The use record file at least records the version of the first file.

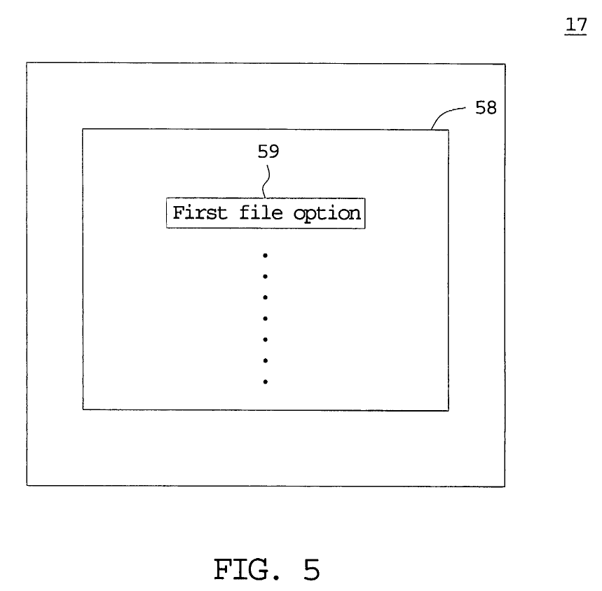

Referring to FIGS. 1-5 at the same time. Firstly, in step 61 of FIG. 6, the computer peripheral 12, 32 or 42 is connected to the server 10 via Internet network 11. Next, proceed to step 62, the computer peripheral 12, 32 or 42 transmits the use record file to the server 10. Then, proceed to step 63, the server 10 receives and stores the use record file from the computer peripheral 12, 32 or 42.

The method of updating files disclosed in the present embodiment of the invention further includes step 64. In step 64, the server 10 determines whether the version of the second file is newer than the version of the first file according to the use record file and the second file.

When the server 10 determines that the version of the second file is newer than the version of the first file, then proceed to step 65, the server 10 transmits the second file to the computer peripheral 12, 32 or 42 via Internet network 11 for the computer peripheral 12, 32 or 42 to update files.

When the server 10 determines that the version of the second file is not newer than the version of the first file, the method is terminated. This implies that the server 10 does not have to transmit the second file to the computer peripheral 12, 32 or 42.

As for how the computer peripheral is automatically or passively connected to the server 10 via Internet network 11 in step 61 has already been disclosed in details in the first to the third embodiments, and is only briefly discussed below

In terms of the computer peripheral 12 of the first embodiment, the computer peripheral 12 is automatically connected to the server 10. The computer peripheral 12 is set to be automatically connected to the server 10 via Internet network 11 at a specific time, a specific period or an idle mode and then transmits use record file to the server 10.

In terms of the computer peripheral 32 of the second embodiment, the computer peripheral 32 include a file updating press-key 36. When the file updating press-key 36 is activated, the computer peripheral 32 is connected to the server 10 via Internet network 11, and then transmit the use record file to the server 10.

In terms of the computer peripheral 42 of the third embodiment, the computer peripheral 42 displays a file-updating menu 58. The file-updating menu 58 includes a first file option 59 corresponding to the first file. When the first file option 59 is selected, the computer peripheral 42 is connected to the server 10 via Internet network 11, and then transmits the use record file to the server 10.

After step 65, the present method of the present embodiment of the invention further several ways of updating files by the computer peripheral. The ways of updating files are disclosed below.

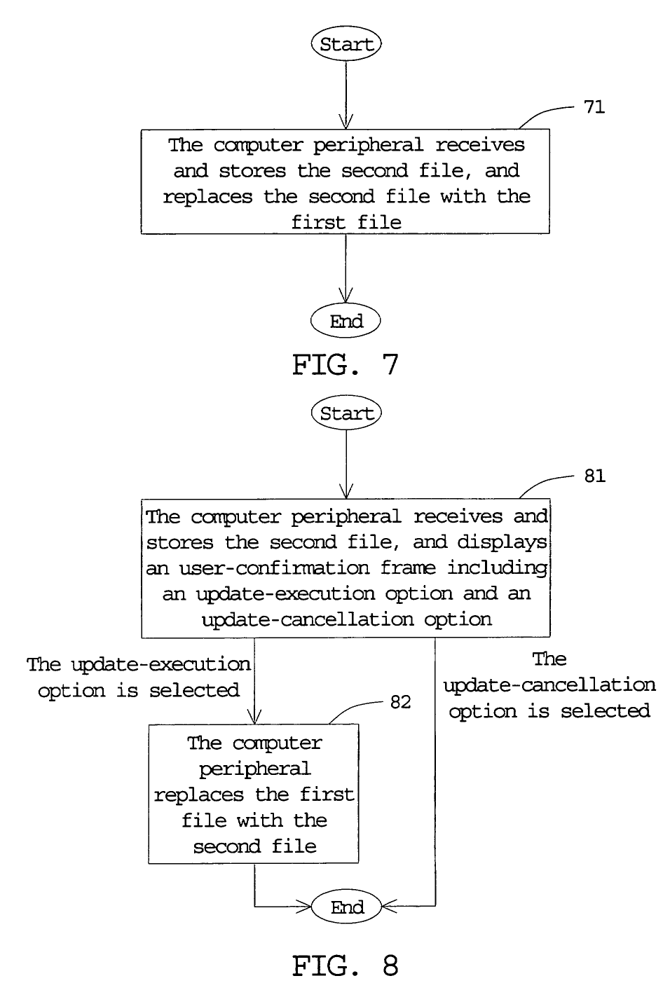

The first way of updating files shown in FIG. 7 includes a step 71 only. In step 71, the computer peripheral 12, 32 or 42 receives and stores the second file, and completes the updating of files by replacing the second file with the first file. Besides, the first file of an older version can be selectively maintained or deleted.

The second way of updating files is shown in FIG. 8. Firstly, in step 81, the computer peripheral 12, 32 or 42 receives and stores the second file, and displays an user-confirmation frame 18 including an update-execution option 19 and an update-cancellation option 20 for an user to choose whether to update the files. When the user selects the update-execution option 19 by the operating unit 16, proceed to step 82, the computer peripheral 12, 32 or 42 completes file updating by replacing the first file with the second file. Besides, the first file of an older version can be selectively maintained or deleted.

When the user selects the update-cancellation option 20 by the operating unit 16, the method is terminated, which implies that the computer peripheral 12, 32 or 42 does not replace the first file with the second file. The user can choose to maintain and does not use the second file until the updating of the files of the computer peripheral 12, 32 or 42 is processed.

According to the computer peripheral and the method of updating files thereof disclosed in above embodiments of the invention, the design of enabling the computer peripheral to automatically or passively transmits the use record file to the server of the manufacturers via Internet network allows the server to determine whether to transmit the file of a newer version to the computer peripheral. Moreover, after the computer peripheral receives the file of a newer version transmitted by the server, the computer peripheral is able to automatically, promptly and efficiently process file updating, lest the user might spend a large amount of time in updating the files of the computer peripheral, largely transcending the restriction of manually updating file of a conventional computer peripheral. Besides, the manufacturer is able to debug the computer peripheral before the user finds the bugs of the computer peripheral, hence increasing the user's approval of the service quality of the manufacturer. The manufacturer can further determine the future directions or debug the possible bugs according to the collected use record file of each computer peripheral.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method of updating files applied in a computer peripheral, wherein the computer peripheral is connected to a server via Internet network, the computer peripheral stores a first file and an use record file, the use record file at least records the version of the first file, and the method comprises:
the computer peripheral connected to the server via Internet network;
the computer peripheral for transmitting the use record file to the server; and
the server for receiving and storing the use record file.

2. The method according to claim 1, the server storing a second file, wherein the method further comprises:
the server for determining whether the version of the second file is newer than the version of the first file according to the use record file and the second file.

3. The method according to claim 2, wherein when the server determines that the version of the second file is newer than the version of the first file, the server transmits the second file to the computer peripheral via Internet network for enabling the computer peripheral to update; and when the server determines that the version of the second file is not newer than the version of the first file, the server does not transmit the second file to the computer peripheral.

4. The method according to claim 3, further comprising: the computer peripheral for receiving and storing the second file, and replacing the first file by the second file.

5. The method according to claim 3, further comprising:
the computer peripheral for receiving and storing the second file, and displaying an user-confirmation frame having an update-execution option and an update-cancellation option;
wherein when the update-execution option is selected, the computer peripheral uses the second file to replace the first file; and
wherein when the update-cancellation option is selected, the computer peripheral does not replace the first file with the second file.

6. The method according to claim 2, wherein the first file and the second file comprise drivers and firmwares.

7. The method according to claim 1, wherein the computer peripheral displays a file-updating menu, the file-updating menu has a first file option corresponding to the first file, when the first file option is selected, the computer peripheral transmits the use record file to the server.

8. The method according to claim 1, wherein the use record file further records the information of the computer peripheral including the model of the computer peripheral, the occurrences of scanning, the occurrences of printing, the occurrences of copying, the occurrences of paper jam, the occurrences of receiving/transmitting facsimiles, the occurrences of e-mails, the occurrences of shut downs, the occurrences of carbon toner cartridge replacement, and the carbon toner cartridge replacement time.

9. The method according to claim 1, wherein the server comprises a database and a website station.

10. A computer peripheral, comprising:
a storage unit for storing a first file and an use record file, wherein the use record file at least records the version of the first file;
a network link unit for enabling the computer peripheral to be connected to a server via Internet network; and
a control unit for controlling the network link unit to be connected to the server via Internet network, wherein the control unit transmits the use record file stored in the storage unit to the server via the network link unit.

11. The device according to claim 10, wherein the server having a second file receives and stores the use record file, and determines whether the version of the second file is newer than the version of the first file according to the use record file and the second file;
wherein when the server determines that the version of the second file is newer than the version of the first file, the server transmits the first file to the computer peripheral via Internet network for the computer peripheral to update; and
wherein when the server determines that the version of the second file is not newer than the version of the first file, the server does not transmit the second file to the computer peripheral.

12. The device according to claim 11, wherein the control unit receives the second file via the network link unit, and stores the received second file in the storage unit, the control unit replaces the first file with the second file.

13. The device according to claim 11, further comprising a display unit and an operating unit, wherein the control unit receives the second file via the network link unit, and stores the received second file in the storage unit, the control unit controls the display unit to display an update-execution option and an update-cancellation option for an user to select via the operating unit;
when the update-execution option is selected, the control unit replaces the first file with the second file; and
when the update-cancellation option is selected, the control unit does not replace the first file with the second file.

14. The device according to claim 13, wherein the display unit and the operating unit include a touch control display panel.

15. The device according to claim 10, wherein the first file and the second file comprise drivers and firmwares.

16. The device according to daim 10, wherein the use record file further records the information of the computer peripheral including the model of the computer peripheral, the occurrences of scanning, the occurrences of printing, the occurrences of copying, the occurrences of paper jam, the occurrences of receiving/transmitting facsimiles, the occurrences of e-mails, the occurrences of shut downs, the occurrences of carbon toner cartridge replacement, and the carbon toner cartridge replacement time.

17. The device according to claim 10, wherein the server comprises a database and a website station.

18. The device according to claim 10, wherein the control unit controls the network link unit to be connected to the server via Internet network when the network link unit is at a default time or a default period or when the computer peripheral is at an idle mode.

19. The device according to claim 18, further comprising an operating unit, wherein the operating unit is for an user to set the default time or the default period.

20. The device according to claim 18, wherein the default time or the default period is in-built in the computer peripheral.

21. The device according to claim 18, wherein the idle mode comprises a stand-by mode, an energy-saving mode and a sleep mode.

22. The device according to claim 10, further comprising a file updating press-key activated to output a file updating instruction, wherein the control unit receives the file updating instruction, and accordingly controls the network link unit to be connected to the server via Internet network, the control unit transmits the use record file stored in the storage unit to the server via the network link unit.

23. The device according to claim 10, further comprising an operating unit and a display unit, the display unit displays a file-updating menu having a first file option corresponding to the first file, the control unit controls the display unit to display the file-updating menu when the operating unit is activated, when the first file option is selected, the control unit controls the network link unit to be connected to the server via Internet network, the control unit transmits the use record file stored in the storage unit to the server via the network link unit.
